(19) United States
(12) Patent Application Publication
(10) Pub. No.: US 2002/0081260 A1
(43) Pub. Date: Jun. 27, 2002

(54) HIGH PRESSURE/HIGH TEMPERATURE PRODUCTION OF COLORLESS AND FANCY COLORED DIAMONDS

(76) Inventors: SURESH SHANKARAPPA VAGARALI, COLUMBUS, OH (US); STEVEN WILLIAM WEBB, WORTHINGTON, OH (US); GEORGE RENE KAPLAN, RYE BROOK, NY (US); WILLIAM EDWIN JACKSON, DUBLIN, OH (US); WILLIAM FRANK BANHOLZER, COLUMBUS, OH (US); THOMAS RICHARD ANTHONY, SCHENECTADY, NY (US)

Correspondence Address: GARY L LOSER, GENERAL ELECTRIC COMPANY, ONE PLASTICS AVENUE, PITTSFIELD, MA, 01201

(21) Appl. No.: 08/953,701

(22) Filed: Oct. 17, 1997

(51) Int. Cl. C01B 31/06

(52) U.S. Cl. 423/446; 423/264; 423/460

(57) ABSTRACT

The present invention is directed to a method for treating discolored natural diamond, especially Type IIa diamond and Type IaA/B diamond with nitrogen as predominantly B centers, for improving its color. The method includes placing a discolored natural diamond in pressure transmitting medium powder which is consolidated into a pill. Next, the pill is placed into a high pressure/high temperature (HP/HT) press at elevated pressure and elevated temperature within the diamond stable range of the carbon phase diagram for a time sufficient to improve the color of said diamond. Finally, the diamond is recovered from said press. Colorless diamond can be made by this method.

### CROSS-REFERENCE TO RELATED APPLICATIONS

None.

### STATEMENT REGARDING FEDERALLY SPONSORED RESEARCH

Not applicable.

### BACKGROUND OF THE INVENTION

The present invention generally relates to the production of gem quality diamond (colorless and fancy colored diamond) and more particularly to the production of gem quality from inferior-grade discolored or so-called “brown” diamond.

Diamonds are conventionally divided into four main categories which are designated as Type Ia, Type Ib, Type IIa, and Type IIb. In reality, there is a smooth change in impurity concentration/arrangement between the four types so that intermediate varieties thereof also exist. Type I diamonds contain nitrogen as the major impurity. This category is divided into Type Ia diamonds where the nitrogen exists in an agglomerated state as either pairs (Type IaA) or clusters of four nitrogen atoms (Type IaB) or mixtures thereof (Type IaA/B), and Type Ib where the nitrogen occurs as only isolated single nitrogen atoms. Some diamond also contain clusters of three nitrogen atoms called N3 centers. Over 98% of the larger clear natural diamonds are Type Ia. Type Ib diamonds are rarer and amount to only 0.8% of natural stones. Type Ia diamonds also contain platelets, which are small flat inclusions a few atoms thick and about 300 atoms across, that may contain some nitrogen in an unspecified form. Type Ia diamonds also may contain voidites which are small equiaxed cavities that are either vacant or which contain nitrogen in an unknown form. Voidites tend to be seen principally in Type IaA/B or Type IaB diamonds.

Generally, it is believed that all nitrogen-containing diamonds started out as Type Ib with isolated nitrogen atoms that were incorporated during crystal growth. During a long period of time (perhaps up to 1 billion years), the diamonds were annealed within earth's mantel at temperatures between 1000° and 1300° C. and at high pressure. During this time, the nitrogen atoms migrated in the diamonds and principally formed two types of aggregates, namely pairs or clusters of four. It is believed that the clusters of four nitrogen atoms are formed when migrating nitrogen pairs collide with each other. Thus, the progression is believed to be Type Ib→Type IaA→Type IaA/B→Type IaB. A small amount of nitrogen may also agglomerate as N3 centers which are a planar array of three nitrogen atoms surrounding a common vacancy. It is believed that such centers are formed when an isolated nitrogen combines with a nitrogen pair during the agglomeration process. N3 centers apparently are less stable than A and B centers as their concentration in Type Ia diamonds is relatively small. Platelets form as soon as the annealing has progressed to the Type IaA stage. Voidite formation, as well as some platelet disintegration, occurs as B clusters form and becomes pronounced in the Type IaB stage of annealing.

Type II diamonds contain no nitrogen. Type II diamonds are further divided into Type IIa's and Type IIb's. Type IIa's have no impurities. Type IIb's contain boron in the parts per million range and are extremely rare.

The color of diamonds can range from clear and colorless to yellow, orange, red, blue, brown, and even green. For natural diamonds, a brownish tinge is the most common color and may occur in as many as 98% of mined natural diamonds. Type Ia diamonds containing nitrogen can be colorless if all of the nitrogen is tied up in A or B centers. However, if isolated nitrogen atoms or N3 centers are present, the diamonds will have a yellow tinge whose hue depends on the concentration of these forms of nitrogen atoms. Typically, the N3 centers produce the washed-out yellow that is referred to as “Cape Yellow”, while isolated nitrogen atoms produce the richer more vibrant “Canary Yellow” if their concentration is high enough. A small amount of yellow in an otherwise colorless diamond can significantly decrease its market price. However, a rich deep yellow color can produce a “fancy” yellow that has a very high value in the marketplace.

Most Type Ia diamonds as mined are of a brownish color. A brown color can result from the mixture of many other fundamental colors. One way is to mix some yellow coloring from isolated nitrogen atoms or N3 centers with some black color, perhaps from submicroscopic inclusions of graphite. The mixture of yellow and black will produce a brown color. Another way to make a brown diamond is to mix a color center that produces a green diamond with a color center that produces a red diamond. The combination of red and green again will produce a brown color. In fact, there are an infinite number of color combinations that will produce a brown color. Thus, it is not possible to determine the color centers causing the color of a diamond by its color. However, the reverse process is unique; that is, if one knows the type and concentration of color centers in a diamond, one can predict the resulting color.

Type II diamonds vary from colorless to a deep blue color. Type Ia diamonds are most valuable when they are colorless. Excessive mechanical deformation and plastic flow are believed to cause them to have a reddish brown or pink tinge which lowers their value considerably. Many natural Type IIa diamonds have this color tinge and their value could be greatly enhanced as jewelry if they could be made colorless. Some Type Ia diamonds have a steel gray haze in them that also greatly decreases their value. Previous attempts to treat Type II a diamonds to increase their value have failed. G. Lenzen, Diamonds and Diamond Grading, p. 207, Buttersworth, London (1983). Both neutron and electron irradiation followed by annealing caused Type IIa diamonds to turn brown, thereby greatly lowering the value of the diamonds.

Type IIb diamonds have a blue color that is imparted by the boron impurity acting as an acceptor. Because of the rarity of Type IIb diamonds and their attractive blue color, they have the highest value per carat as jewelry items.

In general, the pricing of a diamond is a sensitive function of their color. Fancy color diamonds, such as the canary yellows, blue, red, pink and green diamonds, are rare and have the highest prices of any diamonds. Because of their rarity, the market for them is not well organized and they are usually sold via a Sotheby's or Christie's type of auction. Brown diamonds are an exception to the fancy color diamond market. Brown diamonds are very common and in the past have been culled and used as industrial diamonds and are correspondingly inexpensive. Colorless diamonds, such as those marketed extensively by DeBeers, command the highest prices after fancy color diamonds. The degree of colorlessness has a strong nonlinear effect on the price of the diamond. Even the faintest tinge of yellow can considerably reduce the price of colorless diamonds.

In view of the relative prices of fancy colors, colorless, and brown diamonds, there is a strong financial incentive to change brown diamonds to either colorless diamonds or to fancy color diamonds. Irradiation has been used frequently to change the color of such diamonds from unattractive off-colors to attractive blue, green, orange, black, and yellow colors. Electrons, neutrons, gamma rays, and alpha particles have been used to produce irradiation-produced color centers in diamond. Neutron, gamma, and electron irradiation are preferred because they produce a more uniform coloration of the diamond because of their good penetrating power. There is some danger in using neutrons since radioactive species can be produced in inclusions in diamonds by neutron activation. In addition, typical irradiation treatments only develop a superficial color confined to the outer portions of the diamond.

Essentially, all of the different types of radiation produce vacancies in diamond which are seen as the GR1 band in the visible spectrum. Absorption by the GR1 brand produces a green, blue-green, dark green, or even a black color in the diamond. Vacancy color centers can be modified by high-temperature annealing to produce colors ranging from blue to pink to red to green. Annealing can be done at temperatures as low as 600° C., because the large number of vacancies introduced by irradiation temporarily increase the mobility of nitrogen and other impurities in the diamond. Eventually, the vacancies defuse to and are absorbed by vacancy sinks, such as free surfaces, dislocations, and inclusion interfaces in the diamond. Naturally, as the vacancies disappear, their direct effect on the color of the diamond also lessens. Thus, the color gradually goes through a sequence of one from blue to green to brown to yellow and back to the original color of the diamond. The annealing can be stopped at any point of the annealing sequence to produce the color desired. Multiple irradiation steps and annealing steps can be done to further manipulate the color.

In recent years, people have annealed diamonds at progressively higher temperatures to try to eliminate telltale signs of irradiation in the diamond because “treated” diamonds are valued at a discount to natural diamonds. The GR1 line from the vacancy begins to disappear above 400° C. as the vacancies anneal out of the crystal. Other irradiation lines, however, persist to higher temperatures. Much of the information concerning diamond irradiation and annealing treatments is kept as trade secrets by the organizations carrying out such treatments.

An example of a possibly irradiated and heat-treated greenish-yellow diamond was reported in a recent issue of Gems & Gemology, XXXIII, pp. 136-137, (Summer, 1997). Several one carat round brilliant stones were given to the GIA laboratory for testing. From their spectroscopic studies, GIA concluded that these diamonds had been treated. In addition, they inferred that the diamonds had been irradiated and subsequently heated to above 1450° C. Although the normal irradiation signatures, such as the GR1 line at 741 nm and the HIb and HIc lines arising from a combination of irradiation and heat treatment, were absent in these two stones, the stones did have an absorption peak in the near infrared range at 985 nm. Although the detection of treated stones is more of an art than a science, it is commonly believed that diamonds that show no absorption peaks at 595 nm, 1936 nm, and 2024 nm, have “almost certainly not been treated”. J. Wilks, et al., Properties and Applications of Diamonds, p. 91, Buttersworth, London (1991).

Type Ia diamonds in which N3 centers give a slight yellow tinge to the crystal have been the most commonly selected stones for irradiation and annealing treatments. Electron or neutron irradiation of these stones and a subsequent heat treatment generates H3 (Nitrogen-Vacancy-Nitrogen) and H4 (Nitrogen-Nitrogen-Vacancy-Nitrogen-Nitrogen) centers which give a pleasing amber gold color to the stones. It has been found that diamonds that do not luminesce produce more attractive colors than diamonds that luminesce. A. T. Collins, J. Gemology, XVIII, pp. 37-75 (1982). Apparently, existing color centers in the stone add to the color produced by the irradiation and heat treatment, and the resulting color is less desirable.

Changing the concentration of N3 centers not only will change the yellow color of a diamond, but can increase the actual brilliance or amount of light thrown back by the diamond. The electrons around an N3 center absorb light in the ultraviolet part of the natural light spectrum, as well as blue light in the visible spectrum. In normal daylight, about 1/5 of the energy of the light is in the form of ultraviolet radiation. If the N3 concentration is relatively high, i.e., 100 ppm, then visible blue light is strongly absorbed and the diamond will have a definite yellow color, which will lower its value. However, if the concentration of N3 centers is reduced by some treatment so that the yellow coloring disappears, the remaining N3 centers can affect the brilliance of a diamond by a two-stage process. First, an ultraviolet photon is absorbed by an N3 center. The energy is temporarily stored in the N3 center. Some of this energy leaks away in the form of phonons or lattice vibrations. After a storage time pre-determined by the half-life of the center, the N3 center will re-emit the remaining energy as light. Since some energy has been lost, the re-emitted light is no longer in the high energy ultraviolet part of the spectrum. Instead, the re-emitted light now is in the visible spectrum (the technical term for this is “ultraviolet downshifting”). Because we do not see ultraviolet light, we do not notice that it is being absorbed (an animal, like a bee that can see ultraviolet light, would see the brilliance of the diamond decreased by the absorption of ultraviolet light by N3 centers). All we see is the increased emission in the visible spectrum and, thus, the diamond now appears extraordinarily bright. Consequently, a controlled reduction of N3 centers in a Type Ia diamond by any treatment will increase the value of a diamond containing them in two ways. First, elimination of some N3 centers reduces or eliminates the yellow tinge in the diamond. Second, the remaining N3 centers will increase the brilliance of the diamond relative to a perfect Type IIa diamond.

Another approach that has been tried to alter the color of a natural type Ia diamond is to go to very high temperatures and pressures where nitrogen atoms are more mobile. For each 100° Centigrade increase in temperature, the mobility of nitrogen in diamond increases almost an order of magnitude. Evans, et al., Proc Roy Soc Lond, a 344, 111-130 (1975) and Bonzel, et al., Proc Roy Soc Lond, A 361, 109-127 (1978), annealed Type Ia diamonds containing nitrogen at temperatures above 1960° C. under stabilizing pressures as high as 85 kilobars (kbars). The application of pressure is necessary to keep the diamond in the diamond-stable part of the Pressure-Temperature diagram of carbon. F. P. Bundy, Physica, A156, 169-178 (1989). Otherwise, exposure of diamond to such high temperatures would result in the rapid graphitization of the diamond. Most of the diamonds that they treated were of the specific type IaA/B, i.e., they had a mixture of nitrogen clusters comprised of either nitrogen pairs(A) or quadruples(B) since diamonds with either pure IaA or IaB characteristics are very rare. All of the diamonds contained platelets. In the diamonds with predominantly A clusters, the diamonds turned a yellow color as some of the clusters broke up and formed isolated nitrogen atoms (Type Ib). They were less successful in treating diamonds with predominantly B clusters which apparently are more stable than A clusters. The most attractive and deepest yellow colors were obtained with Type Ia diamonds at temperatures between 2250° and 2300° C. and 48 kilobars of pressure (Evans et al., supra.).

Although Evans and co-workers achieved a successful color change, both the Type Ia and IIa diamonds crumbled into small pieces. In other words, the operation was successful but the patient died. Nothing of economic value was created and any original value of the diamonds was destroyed by the treatment. As a result of their work, high-pressure and high-temperature treatments of diamond to change their color were abandoned by the diamond research community in favor of irradiation and low-temperature annealing.

### BRIEF SUMMARY OF THE INVENTION

The present invention is directed to a method for treating discolored natural diamond, especially Type IIa diamond and Type Ia diamond with nitrogen as predominantly B centers, for improving its color. The method includes placing a discolored natural diamond in pressure transmitting medium powder which is consolidated into a pill. Next, the pill is placed into a high pressure/high temperature (HP/HT) press at elevated pressure and elevated temperature within the diamond stable range of the carbon phase diagram for a time sufficient to improve the color of said diamond. Finally, the diamond is recovered from said press. Colorless Type Ia and IIa diamond can be made by this method.

Typical temperatures range from about 1500° to about 2700° C. with corresponding pressures ranging from about 5 to about 20 GPa. Times can range from as short as about 30 seconds up to as long as 96 hours or more with times advantageously ranging from around 5 minutes up to 24 hours. These conditions (time, temperature, and pressure) are correlated and adjusted to the nature of the discoloring defects in the diamond which have to be altered in order to improve the color of the diamond.

Advantages of the present invention include the ability to upgrade the color of discolored or off-colored diamond to produce fancy color diamond or colorless diamond. Another advantage is the ability to maintain the mechanical and structural integrity of the color-improved diamonds. A further advantage is the specific ability to make colorless diamond form Type IIa diamond. A yet further advantage is the ability to retain the optical clarity of the treated diamond disclosed herein. These and other advantages will be readily apparent from the disclosure set forth herein.

### BRIEF DESCRIPTION OF THE DRAWINGS

For a fuller understanding of the nature and objects of the present invention, reference should be had to the following detailed description taken in connection with the accompanying drawings, wherein:

FIG. 1 is a cross-sectional view of a conventional HP/HT apparatus which may utilized to anneal discolored diamond for improving their color.; and

FIG. 2 is a cross-sectional view of a typical reaction cell for annealing natural diamond in the apparatus in FIG. 1.

### DETAILED DESCRIPTION OF THE INVENTION

In the discourse to follow, the precepts of the present invention are illustrated in connection with a conventional HP/HT apparatus which may be of the belt- or die-type described, for example, in U.S. Pats. Nos. 2,947,611; 2,941,241; 2,941,248; 3,609,818; 3,767,371; 4,289,503; 4,673,414; and 4,954,139, the disclosures of which are expressly incorporated herein by reference. However, it will be appreciated that the method of the present invention will find applicability in any HP/HT apparatus of the general type which is capable of providing the required HP and HT conditions simultaneously. Accordingly, it is intended that such other HP/HT apparatuses are within the scope of the invention herein described.

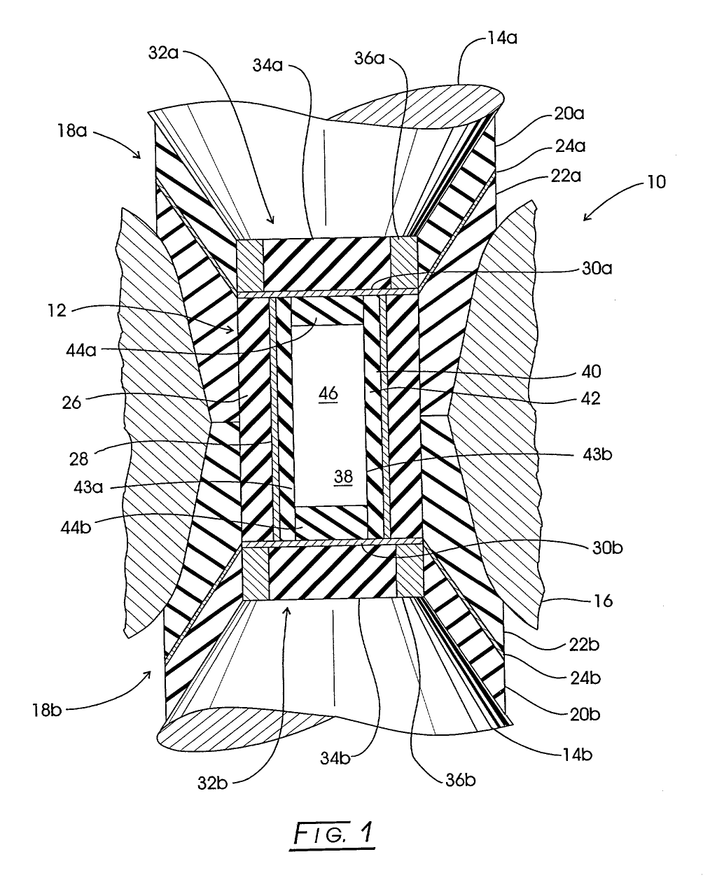

Looking then to FIG. 1, an illustrative HP/HT apparatus or press useful in conjunction with the present invention is shown generally at 10 to comprise a generally cylindrical reaction cell assembly, 12, interposed between a pair of punches, 14a and 14b, and surrounded by a generally annular belt or die member, 16. Preferably, both punches 14 and belt member 16 are formed of a relatively hard material, such as cemented tungsten carbide. Between punches 14 and belt member 16 are a pair of insulating assemblies, 18a and 18b, each of which is formed of a pair of thermally- and electrically-insulating members, 20a-b and 22a-b, each preferably formed of pyrophyllite or the like, and having an intermediate metallic gasket, 24a and 24b, disposed therebetween.

As shown, reaction cell assembly 12 includes a hollow cylinder, 26, which may be formed of a material, such as salt or the like, which is converted during HP/HT by phase transformation or compaction to a stronger, stiffer state, or, alternately of a talc material or the like which is not so converted. In either case, the material of cylinder 12 is selected as being substantially free of volume discontinuities or the like, under HP/HT as may occur, for example, with pyrophyllite or alumina materials. Materials meeting such criteria are described in U.S. Pat. No. 3,030,662, the disclosure of which is incorporated herein by reference.

Positioned concentrically within salt cylinder 26 is an adjacent cylinder, 28, which is provided as a graphite electrical resistance heater tube. Electrical connection with heater tube 28 is achieved via an adjacent pair of conductive-metal end discs, 30a and 30b, which are axially-disposed with respect to heater tube 28. Adjacent each disc 30 is provided an end cap assembly, shown generally at 32a and 32b, each of which comprises an insulating plug, 34a and 34b, surrounded by an electrically conductive ring, 36a and 36b.

It will be appreciated that the interior of heater 28, along with end discs 30, salt cylinder 26, and end cap assemblies 32, defines a generally-cylindrical inner chamber, shown at 38, having defined axial and radial extents and containing a pressure transmitting medium, 40. Pressure transmitting medium 40 is selected as having a relatively low coefficient of internal friction to make it semi-fluid at HP/HT conditions, and may be provided as a cylindrical salt liner, 42, which defines radial pressure transmitting medium layers 43a and 43b, and is fitted with an axial pair of salt plugs, 44a and 44b, each of which defines an axial pressure transmitting medium layer. Preferably, salt liner 42 and plugs 44 are formed of a graphite material or of sodium chloride, but also may can be formed of any chloride, iodide, or bromide of sodium, potassium, or calcium or a mixture thereof. Alternatively, pressure transmitting medium 40 may be provided in powdered or particulate form. In either case, medium 40 defines a cavity space, as is shown at 46, which is configured to receive the discolored diamond to be annealed. Such is the configuration of a representative HP/HT apparatus for practicing the present invention.

In departing from conventional uses of HP/HT apparatuses, the diamond to be annealed is placed within a powdered pressure transmitting medium which then is consolidated or densified to in excess of 90% of its theoretical density to form a pill. The pill medium must transmit hydrostatic pressure without loss as a continuum onto diamond surfaces in the HP/HT apparatus to avoid shear stresses that could plastically deform the diamond being treated. The pill medium also must be thermally and chemically stable, and preferably should not react with or cause dissolution of diamond. Suitable media are stable fluids or gases at annealing conditions or highly plastic solids, including, but not limited to, salts such as describe above, oxides such as magnesium or calcium oxide, or carbons such as graphite. The pill medium also must be scaleable to the high pressures and high temperatures that are encountered with the HP/HT apparatus. Finally, the pill medium must possess a volume compressibility which is small and comparable to the gasketing system, i.e., it must be void-free and close to its theoretical lattice density at annealing conditions. Multiple pills can be housed within cavity 46 if necessary, desirable, or convenient.

HP/HT conditions for the present invention comprehend conditions such that the diamond is thermodynamically stable. Typically, this includes a temperature in the range of about 1500° to 2700° C. and a pressure in the range of about 5 to 20 GPa. Annealing conditions depend upon the nature of the defect in the diamond which have to be removed or changed to improve color. HP/HT conditions are within the diamond stable range of the carbon phase diagram.

HP/HT conditions are maintained for a time adequate for the color of the discolored diamond to improve. Such times can range from minutes to several hours, more typically about 5 minutes to 24 hours, or even more typically about 10 minutes to 2 hours. In this regard, the discolored diamond can be subject to multiple annealing steps at the same or at different conditions, as the examples will demonstrate.

Discolored diamonds subjected to the inventive process may be cut and polished prior to annealing or following their recovery from the pill. Thereafter, the diamond is ready for use in jewelry or fabrication into devices, such as, for example, heat sinks, optical windows, or the like. Of special note, is the ability of the present invention to convert discolored Type IIa diamond into a colorless stone.

The following examples show how the present invention has been practiced, but should not be construed as limiting. In this application, all units are in the metric system, unless otherwise stated. Also, all citations referred to herein are expressly incorporated herein by reference.

### EXAMPLES

### In the Examples

The annealing of natural diamonds was done under high temperature and high pressure conditions using a belt type apparatus which is capable of reaching very high pressures (˜90 kbars) and temperatures (˜2600° C.). A typical procedure for such diamond annealing as reported in the examples follows.

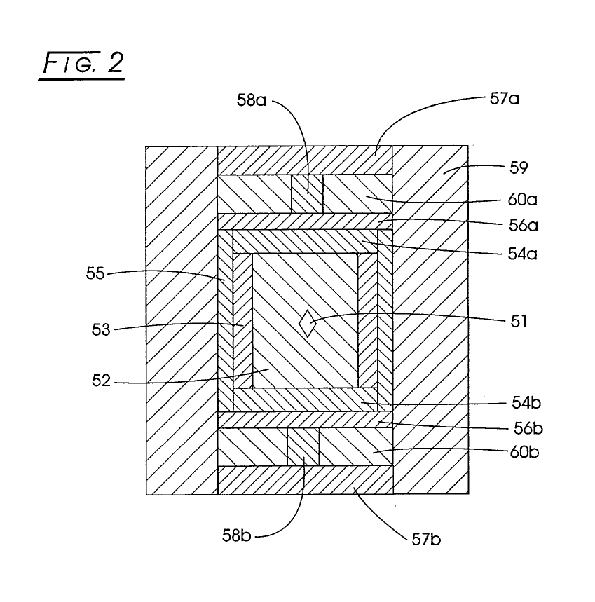

The reaction cell assembly is schematically shown in FIG. 2. Diamond crystal 51 is placed inside cylindrical pill 52 which is made of high purity graphite or sodium chloride powder. Graphite is preferred because it does not melt during high temperature annealing. Pill 52 has the following dimensions: diameter of 0.450″(11.43 mm) and height of 0.500″ (12.7 mm). Pill 52 is made by compacting the graphite powder and diamond crystal 51 in a hydraulic press. Pill 52 is placed within magnesium oxide tube 53 which is fitted with end discs 54a and 54b. This assembly, then, is placed within graphite tube 55 which is fitted with end discs 56a and 56b. Such assembly is placed within salt cylinder 59 whose ends are fitted with graphite pins 58a and 58b surrounded by, respectively, salt cylinders 60a and 60b. Graphite discs 57a and 57b, respectively, seal the ends of salt cylinder 59.

The reaction cell assembly then is placed inside a high pressure apparatus (such as a belt-type apparatus) using standard gasket assemblies to form a seal at high pressure and to make electrical contact with the punches so that it can be heated with electrical power.

A typical annealing run starts with the reaction cell being pressurized to a set pressure of ˜80 kbars. The electrical power is turned on when the pressure reaches ˜96% of the set pressure. Initially, the diamond is heated to ˜1200° C. and held at this temperature for one minute. Thereafter, the temperature is increased to the set value, ˜2300° C., in 2 minutes and held at the set value for 18 minutes. Then, the temperature is slowly reduced to 500° C. in 5 minutes and the power turned off. The cell pressure is held constant for 45 seconds after the power is turned off and the pressure then slowly released. The reaction cell is removed from the high pressure apparatus and the graphite pill containing the diamond is removed. The diamond is recovered by digesting the pill in a boiling mixture of 90% sulfuric acid and 10% nitric acid.

### Example I

A Type IIa natural diamond (Stone No. K11) weighing 244 milligrams and being steel brown in color was embedded inside a graphite pill made by pressing high purity graphite powdered. The diamond was annealed at ˜80 kbars and 2300° C. for 18 minutes. The diamond crystal was recovered and visual examination showed that its color had changed to clear or colorless. The change in color became more evident after polishing flats on the surface of the annealed diamond.

### Example II

A Type Ia natural diamond (Stone No. F 1816) weighting 210 milligrams and light brown in color was placed inside a pill made by pressing high purity sodium chloride powder. The diamond was annealed at ˜80 kbars and ˜2400° C. for 18 minutes. Visual examination of the recovered diamond showed that the color had changed to golden yellow.

### Example III

A Type Ia natural diamond (Stone No. K38) weighing 160 milligrams and medium brown in color was placed inside a pill made by pressing high purity sodium chloride powder. The diamond was annealed at ˜77 kbars and ˜1900° C. for 18 minutes. Visual examination of the recovered diamond showed that there was no change in color. The diamond was annealed again at ˜79 kbars and ˜2050° C. for 18 minutes which resulted in a change in color to light yellow. The diamond was annealed for a third time at ˜79 kbars and 2200° C. for 18 minutes which resulted in a change in color to greenish-golden yellow. The spectrum of this stone in the UV, visible, near infrared, and infrared spectra showed no unusual absorption lines that are not seen in natural diamond stones. Specifically, the normal irradiation signatures, such as the GR1 line at 741 nm and the H1b and H1c lines arising from a combination of irradiation and heat treatment were absent, as well as was an absorption peak in the near infrared at 985 nm that had been previously seen by GIA laboratory in a greenish-yellow stone that had been “treated”. Gems and Gemology, supra.

### Example IV

A Type Ia natural diamond (Stone No. K40) weighing 118 milligrams and dark brown in color was placed inside a pill made by pressing a mixture containing 96% high purity sodium chloride and 4% potassium nitrate powders. The diamond was annealed at ˜80 kbars and 2300° C. for 18 minutes which resulted in a change in color to greenish golden yellow. The spectrum of this stone in the UV, visible, near infrared, and infrared spectra showed no unusual absorption lines that are not seen in natural diamond stones. Specifically, the normal irradiation signatures, such as the GR1 line at 741 nm and the H1b and H1c lines arising from a combination of irradiation and heat treatment were absent, as well as was an absorption peak in the near infrared at 985 nm that had been previously seen by GIA laboratory in a greenish-yellow stone that had been “treated”. Gems and Gemology, supra.

### Examples V

Three type Ia diamonds, K58-12, K58-61, and K58-62, weighing 31.6, 27.1, and 24 milligrams with initial colors of light brown, dark brown, and dark brown, respectively, were placed inside a pill by pressing a high purity graphite. The diamonds were IaA/B type with nitrogen present in A and B centers. However, in both the K58-61 and K58-62 diamonds, nitrogen was present mainly in B centers. The diamonds were annealed at 79 kbar and 2300° C. for 18 minutes. Visual examination of the recovered diamonds showed that K58-12 had changed to a deep yellow, K58-61 to a very light yellow, and K58-62 had changed to colorless.

### Examples VI

Three type Ia diamonds, K58-10, K59-40, and K59-60, weighing 26.4, 21.6, and 30.3 milligrams with initial colors of light brown, brown, and brown, respectively, were placed inside a pill by pressing a high purity graphite powder. K58-10 was a type IA/B diamond, whereas both K59-40 and K59-60 were type IaA/B diamonds. The diamonds were annealed at 79 kbar and 2000° C. for 18 minutes. Visual examination of the recovered diamonds showed that K58-10 had become colorless, whereas both K59-40 and K59-60 had no change in color.

Examples V and VI indicate that some type Ia diamonds can be made colorless by annealing under high pressure and high temperature conditions.

### Examples VII-XX

Additional diamond samples were annealed by the procedures described above. The results of such annealing procedure, along with the previous examples, is set forth in the following table in which the temperatures and pressures reported are estimated values as is common in the HP/HT industry.

TABLE I

| | | Color Before | | Pressure | Temperature | Time | Color After |
|---|---|---|---|---|---|---|---|
| Stone No. | Diamond Type | Annealing | Medium | (Kbar) | (° C.) | (min) | Annealing |
| K11 | IIa | steel brown | graphite | 80 | 2300 | 18 | colorless |
| K18 | Ia | light brown | graphite | 80 | 2300 | 20 | pale green |
| K35 | Ia | light brown | graphite | 80 | 2300 | 18 | yellow |
| K37 | Ia | light brown | graphite | 77 | 1900 | 18 | light brown |
| (1st run) | | | | | | | |
| K37 | Ia | light brown | sodium chloride | 80 | 2400 | 12 | yellow |
| (2nd run) | | | | | | | |
| K38 | Ia | medium brown | sodium chloride | 77 | 1900 | 18 | medium brown |
| (1st run) | | | | | | | |
| K38 | Ia | medium brown | sodium chloride | 79 | 2050 | 18 | light yellow |
| (2nd run) | | | | | | | |
| K38 | Ia | light yellow | 99% NaCl + | 79 | 2200 | 18 | greenish- |
| (3rd run) | | | 1% KNO₃ | | | | golden yellow |
| K45 | Ia | dark brown | graphite | 80 | 2300 | 17 | yellow |
| K43 | Ia | light brown | sodium chloride | 80 | 2200 | 18 | light greenish |
| | | | | | | | yellow |
| K40 | Ia | dark brown | 96% NaCl + | 80 | 2200 | 18 | greenish- |
| | | | 4% KNO₃ | | | | golden yellow |
| K44 | Ia | light brown | sodium chloride | 80 | 2300 | 18 | light yellow |
| F1813 | Ia | light brown | sodium chloride | 80 | 2300 | 18 | light yellow |
| (1st run) | | | | | | | |
| F1813 | Ia | light yellow | sodium chloride | 80 | 2400 | 18 | brownish |
| (2nd run) | | | | | | | yellow |
| F1814 | Ia | very light | sodium chloride | 80 | 2200 | 18 | light yellow |
| (1st run) | | brown | | | | | |
| F1814 | Ia | light yellow | sodium chloride | 80 | 2400 | 18 | golden yellow |
| (2nd run) | | | | | | | |
| F1816 | Ia | light brown | sodium chloride | 80 | 2400 | 18 | golden yellow |
| K56-1 | IIa | light brown | sodium chloride | 80 | 2300 | 18 | colorless |
| K58-12 | IaA/B | light brown | graphite | 79 | 2300 | 18 | deep yellow |
| K58-61 | IaA/B | dark brown | graphite | 79 | 2300 | 18 | very light |
| | | | | | | | yellow |
| K58-62 | IaA/B | dark brown | graphite | 79 | 2300 | 18 | colorless |
| K58-10 | IaA/B | light brown | graphite | 79 | 2000 | 18 | colorless |
| K59-40 | IaB | brown | graphite | 79 | 2000 | 18 | brown |
| K69-60 | IaB | brown | graphite | 79 | 2000 | 18 | brown |

1. A method for treating discolored natural diamond for improving its color, which comprises the following steps:
(a) placing a discolored natural diamond in pressure transmitting medium powder which is consolidated into a pill;
(b) placing said pill into a high pressure/high temperature (HP/HT) press at elevated pressure and elevated temperature within the diamond stable range of the carbon phase diagram for a time sufficient to improve the color of said diamond; and
(c) recovering said diamond from said press.

2. The method of claim 1, wherein said discolored natural diamond is a Type Ia or Type Ib diamond.

3. The method of claim 1, wherein said discolored natural diamond is Type Ia or IIb diamond.

4. The method of claim 3, wherein the diamond recovered from the press is colorless.

5. The method of claim 1, wherein the diamond recovered from the press is colorless or a fancy colored diamond.

6. The method of claim 1, wherein said elevated temperature ranges from about 1500° to 2700° C. and said elevated temperature ranges from about 5 to 20 GPa.

7. The method of claim 6, wherein said HP/HT conditions are maintained for a time ranging from between about 30 seconds and 96 hours.

8. The method of claim 1, wherein said recovered diamond is subjected to step (b) a plurality of times.

9. The method of claim 1, wherein said pressure transmitting medium is thermally and chemically stable at HP/HT and is one or more of a salt, an oxide, or graphite.

10. The method of claim 9, wherein said pressure transmitting medium salt is one or more of a chloride, iodide, or bromide of sodium, potassium, or calcium, or a mixture thereof.

11. The method of claim 9, wherein said pressure transmitting medium oxide is one or more of an oxide of magnesium, calcium, or mixtures thereof.

12. The method of claim 9, wherein said pressure transmitting medium is graphite.
